(19) United States
(12) Patent Application Publication
(10) Pub. No.: US 2020/0258059 A1
(43) Pub. Date: Aug. 13, 2020

(54) TEMPORARY ATM CARD SYSTEM AND METHOD

(71) Applicants: Alan David Filby, San Rafael, CA (US); Andrew Paul Hayes, Charlotte, NC (US)

(72) Inventors: Alan David Filby, San Rafael, CA (US); Andrew Paul Hayes, Charlotte, NC (US)

(73) Assignee: Wells Fargo Bank, NA

(21) Appl. No.: 13/355,073

(22) Filed: Jan. 20, 2012

(51) Int. Cl. G06Q 20/04; G06Q 20/10

(52) U.S. Cl. CPC G06Q 20/0425; G06Q 20/1085

(57) ABSTRACT

An automated teller machine comprises an envelope-free deposit slot mechanism configured to receive a funds deposit from a user. The automated teller machine further comprises control logic configured to cause the deposit slot mechanism to receive an authentication printout from the user and to optically scan information printed on the authentication printout. The automated teller machine further comprises an authentication circuit configured to authenticate the transaction based on the information scanned from the authentication printout. The automated teller machine further comprises a cash dispenser mechanism configured to dispense cash to the user. Cash is dispensed to the user responsive to authentication of the user based on the authentication printout.

### BACKGROUND

Automated teller machines (ATMs) provide customers of banks with a convenient way to obtain cash. ATMs can be accessed with an ATM card and an associated personal identification number (PIN). However, customers sometimes lose their ATM cards, or their ATM cards are stolen, making it impossible for the customers to access ATMs. After the customer informs their bank that their ATM card has been lost or stolen, the bank issues a new ATM card. In the interim, before the new ATM card is received, the customer can go to a local branch to obtain a temporary ATM card and/or make cash withdrawals. In other situations, a customer may simply choose not to have an ATM card, likewise making it impossible for the customer to access ATMs.

### SUMMARY

According to an example embodiment, a method comprises receiving, by an envelope-free deposit slot mechanism of an automated teller machine, an authentication printout from a user. The method further comprises optically scanning, by the envelope-free deposit slot mechanism, information printed on the authentication printout. The method further comprises authenticating, by an authentication circuit of the automated teller machine, the transaction based on the information scanned from the authentication printout. The method further comprises effecting, by a transaction processing circuit of the automated teller machine, a transaction based on the authentication of the user.

According to another example embodiment, an automated teller machine comprises an envelope-free deposit slot mechanism configured to receive a funds deposit from a user. The automated teller machine further comprises control logic configured to cause the deposit slot mechanism to receive an authentication printout from the user and to optically scan information printed on the authentication printout. The automated teller machine further comprises an authentication circuit configured to authenticate the transaction based on the information scanned from the authentication printout. The automated teller machine further comprises a cash dispenser mechanism configured to dispense cash to the user. Cash is dispensed to the user responsive to authentication of the user based on the authentication printout.

### BRIEF DESCRIPTION OF THE DRAWINGS

FIG. 1 shows a hardware system in which authentication printouts may be generated for a customer according to an example embodiment.

FIG. 2 is a flowchart showing generation of an authentication printout according to an example embodiment.

FIG. 3 is a flowchart showing operation of an ATM in connection with an authentication printout according to an example embodiment.

FIG. 4 is a flowchart showing operation of a bank computer system when an authentication printout is received at an ATM according to an example embodiment.

### DETAILED DESCRIPTION OF EXAMPLE EMBODIMENTS

Example embodiments provide an alternative solution for customers of banks to obtain cash from an automated teller machine (ATM). In one embodiment, an online or mobile banking customer with access to a printer can print an authentication printout on paper. The authentication printout may be a temporary copy of an ATM card, a temporary copy of a credit card, or other printout encoded with information. An ATM may be provided that permits the customer to insert the authentication printout into an envelope-free deposit slot mechanism at the ATM without requiring a swipe of an ATM card, credit card, etc. For example, the customer may press a button (e.g., labeled “Emergency Cash”) that activates the deposit slot mechanism without requiring a card swipe. The authentication printout may then be optically scanned by the envelope-free deposit slot mechanism and the transaction may be authenticated. Various embodiments provide a solution that allows a customer to obtain cash from an ATM without physically going to a branch office location of the bank.

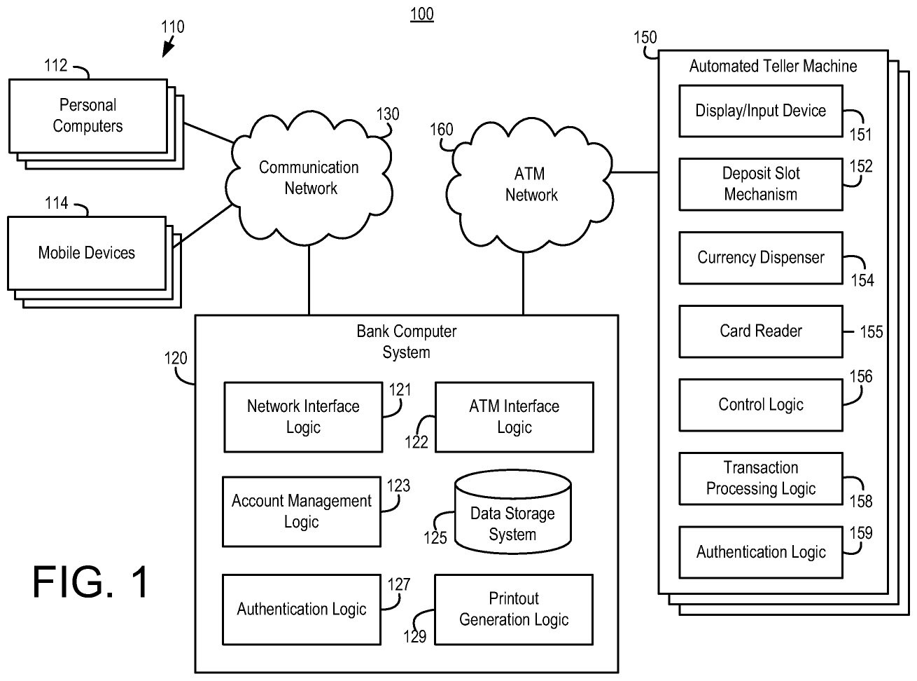

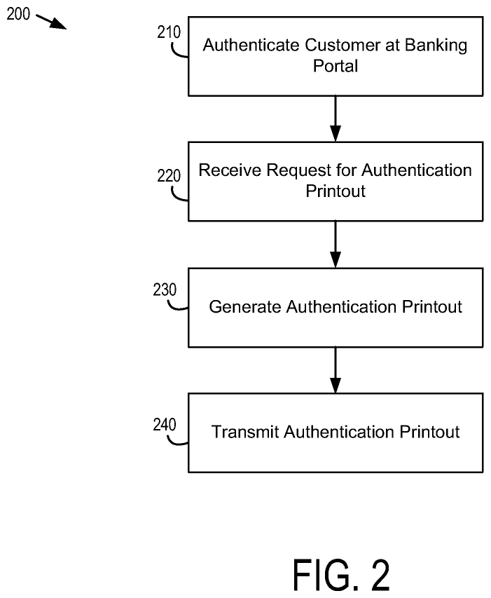

FIG. 1 below shows a hardware system in which authentication printouts may be generated for a customer. FIGS. 2-4 show operation of the system of FIG. 1 in connection with such authentication printouts. While FIGS. 1-4 show one possible implementation, it will be appreciated that other implementations are also possible.

Referring first to FIG. 1, FIG. 1 shows a system 100 according to an example embodiment. The system 100 may include a plurality of user devices 110, a bank computer system 120, and a plurality of automated teller machines (ATMs) 150. For example, the user devices 110 may comprise personal computers 112, mobile devices 114, and so on, which are connected to the bank computer system 120 by way of a communication network 130 (e.g., the Internet). The ATMs 150 may be connected to the bank computer system 120 by way of an ATM communication network 160. The user devices 110 and the ATMs 150 may be used by customers (i.e., account holders) of the bank to access their accounts and, in the case of the ATMs 150, to obtain cash. As will be appreciated, while some of the ATMs 150 may be owned/operated by the same entity that owns/operates the bank computer system 120, other of the ATMs 150 may be owned by other entities (e.g., other banks).

The bank computer system 120 includes network interface logic 121, ATM interface logic 122, account management logic 123, data storage system 125, authentication logic 123, and code generation logic 129. In practice, the bank computer system 120 including logic 121-129 may be implemented by computer systems, for example, comprising one or more networked computer servers having non-transitory machine readable media. The logic 121-129 may therefore be implemented as program logic circuits that are stored on the non-transitory machine-readable storage media and that, when executed by processor(s) of the server(s), causes the servers to perform the operations described herein.

Network interface logic 121 may, for example, be configured to connect the bank computer system 120 to the Internet or other network 130 to permit account holders to access the bank computer system 120 through an on-line banking area of a website of the bank. For example, network interface logic 121 may be configured to generate a graphical user interface (e.g., one or more dynamically generated web pages presented to the customer via a browser application operating at devices 112 or 114). The user interface may prompt the users to take certain actions and may receive user inputs provided in response to such prompting. Network interface logic 121 may also comprise other logic that is configured to provide an interface for other types of devices such as mobile devices (cell phones, smart phones, and so on). ATM interface logic 122 may be configured to connect the bank computer system 120 to communicate with other systems such as the ATMs 150. ATM interface logic 122 may be configured to communicate with the automated teller machine 150 over a proprietary encrypted network, a public encrypted network, or other suitable network.

Account management logic 123 includes stored program logic that performs various tasks in connection with accounts held by account holders at the financial institution. For example, the account management logic 123 may perform account processing to process transactions in connection with the account(s) of the account holder, such as account debits and credits to checking and savings accounts, credits and debits to home mortgage and home equity accounts, credits and debits to student loan accounts, and so on. For example, in the context of demand deposit accounts, the transactions may also include funds transfers in which funds are transferred into or out of such accounts (e.g., electronic bill payment transactions in which monies from the checking account of the user are used to pay bills received by the user). Account management logic 123 may also generate statements for the user relating to the user's account(s).

The data storage system 125 may include an account database configured to store account-related information generated by the account management logic 123, such as logs of each transaction performed by the account management logic 123. The account management logic 123 may store data related to the account in data storage system 125. The data storage system 125 may be configured store other information such as account balance and other account holder related information (e.g., preferences, profiles, login credentials, and so on).

The authentication logic 127 includes program logic configured to authenticate users attempting to perform transactions. For example, the authentication logic 127 may authenticate users at the on-line banking area of the website of the bank (e.g., based on login name/password and other credentials such as responses to challenge questions). The authentication logic 127 may also authenticate a customer at the same time the authentication logic 159 authenticates a customer, i.e., when the customer is attempting to perform a transaction at an ATM.

The printout generation logic 129 is configured to generate authentication printouts. The authentication printouts may have different/varying amounts of information printed thereon according to different embodiments, depending in part on the authentication mechanism that is employed, as described below. For example, the authentication printout may have the customer's card number. As another example, the authentication printout may have information contained in the magnetic strip of ATM cards (e.g., PIN verification value, PIN key value, and so on). As another example, the authentication printout may have a unique code that permits the authentication printout to be correlated with information stored in the data storage system 125 regarding the authentication printout (e.g., transaction limits, number of uses, other credential information, and so on). Various permutations and combinations of the above and other information may be used. As will be appreciated, such information may be encrypted and embedded in a code (e.g., a barcode).

The automated teller machine 150 may include a display/input device 151, a deposit slot mechanism 152, a currency dispenser 154, a card reader 155, user interface logic 156, transaction processing logic 158, and authentication logic 159. Again, the logic 151-159 may be implemented as program logic circuits that is stored on non-transitory machine-readable storage media and that, when executed by one or more processors, causes the processor(s) to perform the operations described herein.

The display/input device 151 may, for example, comprise a touch screen display or other suitable combination of devices (e.g., separate display and keypad) to enable the customer to interact with the automated teller machine 150 to conduct transactions. The transactions may include withdrawing funds, purchasing one or more goods or services, transferring funds from one account to another account, changing/updating account information, and so on. The display/input device 151 may be used to display various menu options relating to such transactions to the account holder.

The envelope-free deposit slot mechanism 152 accepts envelop or envelop-free deposits of checks. For envelope-free deposits, customers insert checks to be deposited directly into the ATM without using a deposit envelope. The deposit slot mechanism 152 may include a scanner capable of scanning images of checks placed in the deposit slot mechanism 152. As will be appreciated, the ATM 150 may be configured to have the deposit slot mechanism 152 accept other sheets of paper having the same general form-factor as a check.

The currency dispenser 154 may dispense currency notes (“cash”) to an account holder from their financial institution accounts. The currency dispenser 154 may be configured to dispense currency in various denominations.

The card reader 155 may be configured to read information from a transaction card (e.g., an ATM card, a credit card, a stored value card, etc.). For example, the card reader 155 may scan information from the magnetic stripe (“magstripe”) of the transaction card. While performing the read operation, the card reader 155 may be configured to read the account information and the PIN associated with the card and the account.

The control logic 156 controls the devices 151, 152, 154 and 156. For example, the control logic 156 may generate a graphical user interface for presentation to a user at the automated teller machine 150 via the display/input device 151. The control logic 156 may also activate and otherwise control operation of the deposit slot mechanism 152, the currency dispenser 154 and the card reader 155.

The transaction processing logic 158 may be configured to process each transaction requested by the account holder. For example, the transaction processing logic 158 may cooperate with the account management logic 122 at the bank computer system 120 to ensure that transactions are properly debited/credit to the account of the account holder.

The authentication logic 159 may authenticate transactions at the ATM 150. In order for the ATM transaction to occur, the ATM is authenticated at both the bank computer system 120 and at the ATM machine 150. That is, the ATM 150 may authenticate the transaction based on information received from the user (e.g., the authentication printout and other credentials) and based on information received from the bank computer system 120 (e.g., an authorization signal that indicates that the transaction is authorized). If the transaction is not authenticated at the ATM 150, the ATM 150 does not dispense cash to the user. Likewise, the bank computer system 120 may authenticate the transaction based on information received from the ATM 150 (e.g., the authentication printout and other credentials) and based on other information contained in the bank computer system 120 or obtained from a computer system of another bank (e.g., whether the user has enough available funds to permit the transaction to proceed). The ATM 150 may provide information about the authentication printout and the credentials to the bank computer system in a variety of ways (e.g., the raw data, an indication that the ATM determined the credentials provided by the user to be valid, and so on). If the transaction is not authenticated at the bank computer system 120, the bank computer system 120 does not generate the authorization signal for the ATM 150 indicating that the transaction may proceed. As will be appreciated, depending on whether authentication information is contained on the authentication printout, in the data storage system 125, or both, various approaches may be used for determining whether authentication information provided by the user matches authentication information contained on the authentication printout or stored in the data storage system 125, including whether such determination is made by the authentication logic 127 or the authentication logic 159.

In an example embodiment, the authentication logic 127 and/or the authentication logic 159 includes logic to prevent a fraudster from printing out many copies of an authentication printout and using the many copies to test every possible PIN or other credential that might be associated with the authentication printout. For example, if a four digit PIN is employed, it may be desirable to prevent a fraudster from testing all 10,000 possible PIN values until the correct PIN is reached. For example, the authentication logic 127 and/or the authentication logic 159 may be configured to invalidate the authentication printout after a predetermined number of PINS have been attempted.

Referring now to FIG. 2, a flowchart showing generation of an authentication printout is shown. For example, a customer may decide to obtain an authentication printout useable to access an ATM machine, e.g., upon having a transaction card lost or stolen. For purposes of providing an example, it is assumed herein that the transaction card is an ATM card. As will be appreciated, however, the arrangement described herein may be provided in connection with other types of transaction cards (e.g., credit cards, stored value cards, etc.). Additionally, for purposes of providing an example, it is assumed that the transaction card is used in connection with a demand deposit account (e.g., a checking account) held by the customer at a bank. As will be appreciated, however, the arrangement described herein may also be used in connection with other types of accounts, such as credit card accounts, savings accounts, personal lines of credit, other revolving credit accounts, and so on. In particular, the arrangement may also be used with accounts that do not typically have an associated transaction card (e.g., a personal line of credit). Hence, the customer may decide to obtain an authentication printout as a convenient way to obtain cash from the customer's personal line of credit, without having had a transaction card lost or stolen.

At step 210, the user is authenticated at an electronic banking session. In an example embodiment, the authentication printout may, for example, be provided to the customer via services offered through an online banking website of a bank that provided the transaction card. In such an example, the customer may access the online banking website using personal computer 112 and present proper credentials (e.g., username and password) at the online banking website. As another example, the customer may access the services described herein via other channels, such as a mobile channel using mobile computing device 114.

At step 220, user inputs are received requesting an authentication printout and specifying other parameters of the authentication printout. For example, the user may select links that cause the interface logic 121 to respond with web pages relating to the authentication printout. Such web pages may further prompt the customer to provide additional information. In some embodiments, the authentication printout provides the customer with the same access to their accounts that the lost/stolen ATM card provided. In other embodiments, the authentication printout provides the customer with more limited access. For example, the customer may be prompted to specify a dollar amount for the authentication printout such that, when the authentication printout is received at the ATM, only the pre-specified dollar amount is dispensed at the ATM. As another example, the customer may be prompted to provide a security password such that, when the authentication printout is received at the ATM, the security password must be re-entered at the ATM in order for cash to be dispensed. The security password may be in addition to or instead of the PIN that typically would be needed to be entered by the customer. For example, if the person that will be using the authentication printout is different than the customer (e.g., a friend or relative of the customer), the customer may not wish to provide that person with the customer's actual PIN. If the display/input device 150 comprises a touch screen display (capable of displaying a QWERTY keyboard), the password may be any alphanumeric string of characters (e.g., the e-mail address of the third party, the phone number of the third party, or any other mutually known piece of information).

As another example, the user may be permitted to specify whether the authentication printout is a single-use printout or a multi-use printout. For example, if the authentication printout is a single use printout, then once the authentication printout has been used at an ATM machine, the authentication printout is no longer valid and future transactions using additional copies (e.g., additional printouts or photocopies) of the authentication printout will not be authenticated. (Unlike card readers, deposit slot mechanisms typically do not return papers (e.g., deposited checks) to a customer once those papers have been inserted into the deposit slot mechanism.) This arrangement may be useful, for example, if the authentication printout is transmitted to a third party (e.g., a friend or relative), as the customer may not wish to give the third party unfettered ability to withdraw funds from the customer's account. If the authentication printout is a multi-use printout, then once the authentication printout has been used at an ATM machine, the authentication printout remains valid and future transactions using additional copies of the authentication printout will be authenticated. This arrangement may be useful if the authentication printout is used by the customer or a highly trusted friend or relative. In one embodiment, after all the parameters of the ATM card have been specified, a database entry for the authentication printout along with other such information specified by the customer as described above may be stored in data storage system 125 for later retrieval when the authentication printout is presented at an ATM.

At step 230, an authentication printout is generated for printing by the user. For example, the authentication printout may comprise an image of the customer's ATM card (e.g., including the card number). As another example, the authentication printout may comprise a coded image (e.g., a barcode) that may be optically scanned at the ATM to obtain authentication information and other transaction-related information. For example, the coded image may contain a code that is useable to access the database entry described above. As another example, the coded image may have embedded therein information specified by the user (e.g., dollar amounts, required passwords, and so on).

At step 240, the authentication printout is transmitted to the user. For example, the authentication printout may be transmitted to a web browser of the user and, from the web browser, the user may print out the authentication printout on a nearby printer. As indicated above, the authentication printout may also be used at the ATM by a person other than the customer (e.g., a friend, relative, etc.). Hence, rather than printing the authentication printout on a nearby printer, the customer may decide to electronically send the authentication printout to another person (e.g., via e-mail, fax, photocopying, etc.). (Unlike government-issued currency, for example, in which fraud-prevention security is provided by making the currency difficult to physically reproduce, fraud-prevention security for the authentication printout is provided vis-à-vis requirements that may be provided at the ATM for the user to provide PINS, passwords, etc. Hence, the authentication printout may be made to be relatively easy to reproduce without necessarily compromising security.) In an example embodiment, the customer may be prompted to provide the e-mail address and/or cell phone number of the third party. Upon receiving such information, the printout generation logic 129 may be configured to both set the e-mail address/phone number as the security password for the authentication printout (as discussed above in connection with step 220) and to transmit the authentication printout to the third party at the provided e-mail address/phone number.

In various embodiments, other content may be provided on the authentication printout that is not directly related to the conduct of one or more transactions at an ATM. Because the authentication printout only needs to present a coded image, there may be surplus space available on the printout (including on the back) to include personalization, branding, or advertising. For example, the customer may decide to place a picture on the authentication printout (e.g., a headshot of the customer). As another example, branding content (e.g., a bank logo) may be placed on the authentication printout. As another example, advertising space on the authentication printouts may be sold to third parties and advertisements may be placed on the authentication printout. As another example, sweepstakes or other contests may be conducted through the authentication printouts. For example, the authentication printout may contain a message that states: “Congratulations! You have won up to $300. Simply print out this code and take it to any ATM and enter your personalized PIN to see how much you've won.” Upon receiving the authentication printout at an ATM, the sweepstakes prize may be dispensed to the bearer of the authentication printout.

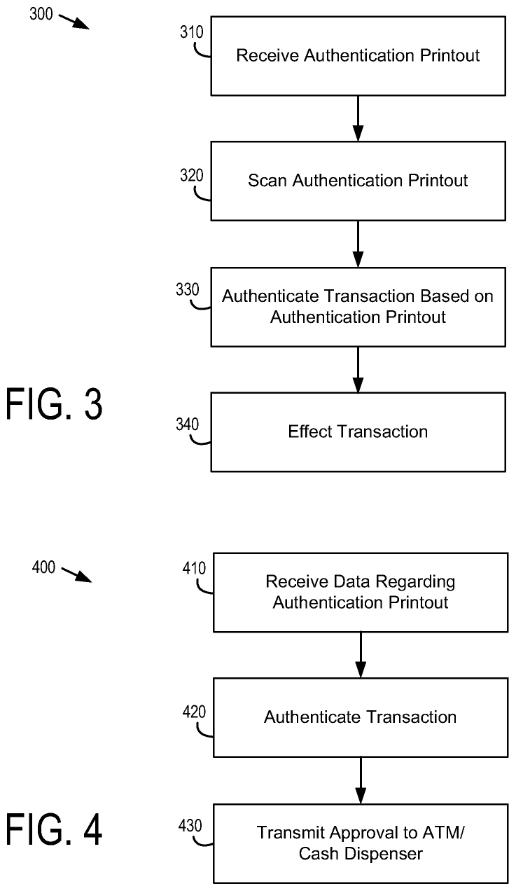

Referring now to FIG. 3, a flowchart showing operation of an ATM in connection with an authentication printout is shown. At step 310, the deposit slot mechanism 152 of an automated teller machine 150 receives an authentication printout from a user. The deposit slot mechanism 152 may receive the authentication printout responsive to control signals provided by the control logic 156. For example, the control circuit may cause a button to be presented by the display/input device 151 (e.g., a button labeled “Emergency Cash” presented on a touch screen display) that, when pressed, activates the deposit slot mechanism 152.

At step 320, the envelope-free deposit slot mechanism optically scans information printed on the authentication printout. As previously indicated, the authentication printout may have different/varying amounts of information printed thereon according to different embodiments, depending in part on the authentication mechanism that is employed. In addition to providing the authentication printout, the user may also be required to provide other information (e.g., via a keypad or other input device 151) in order to authenticate the transaction (e.g., the dollar amount of the transaction, other information matching information that is contained in the authentication printout, other information specified by the customer during the online banking session during which the authentication printout was created, and so on).

At step 330, the authentication logic 159 authenticates the user based on the information scanned from the authentication printout. As previously indicated, this authentication is in addition to authentication performed at the bank computer system 120. Once an authorization signal is received from the bank computer system 120, at step 340, transaction processing circuit 158 of the automated teller machine effects a transaction based on the authentication of the user. For example, if the transaction is to obtain cash, the transaction processing circuit 158 cooperates with the control logic 156 to cause the currency dispenser 154 to dispense cash to the user. Other transactions may also be performed (e.g., purchasing stamps, balance transfers, viewing or changing account information, and so on).

Referring now to FIG. 4, FIG. 4 is a flowchart showing operation of a bank computer system when an authentication printout is received at an ATM according to an example embodiment. At step 410, data regarding the authentication printout and other authentication information provided by the user are received from an ATM 150. The ATM 150 may provide information about the authentication printout and the credentials to the bank computer system in a variety of ways (e.g., the raw data, an indication that the ATM determined the credentials provided by the user to be valid, and so on).

At step 420, the transaction is authenticated. The bank computer system 120 may authenticate the transaction based on information received from the ATM 150 (e.g., the authentication printout and other credentials) and based on other information contained in the bank computer system 120 or obtained from a computer system of another bank (e.g., whether the user has enough available funds to permit the transaction to proceed). At step 430, an approval signal is transmitted to the ATM 150 indicating that the transaction is approved.

It may be noted that the arrangement described herein may be configured to operate across systems of different banks. For example, a customer of bank A that does not offer authentication printouts may access a website of bank B that does offer authentication printouts. An authentication printout may be generated for the customer in the manner described above. Bank B may then initiate an interbank transfer of funds and dispense those funds the next time the customer visits an ATM machine of Bank B (e.g., a few days later). Alternatively, authorization for the transaction may be obtained in real time (i.e., akin to the manner in which an ATM card of Bank A would be permitted to conduct a transaction at an ATM machine of Bank B).

The embodiments of the present invention have been described with reference to drawings. The drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising non-transitory machine-readable media for carrying or having machine-executable instructions or data structures stored thereon. Such machine-readable media may be any available media that may be accessed by a general purpose or special purpose computer or other machine with a processor. By way of example, such machine-readable media may comprise RAM, ROM, EPROM, EEPROM, CD-ROM or other optical disk storage, magnetic disk storage or other magnetic storage devices, or any other medium which may be used to carry or store desired program code in the form of machine-executable instructions or data structures and which may be accessed by a general purpose or special purpose computer or other machine with a processor. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include one or more general purpose computers including a processing unit, a system memory or database, and a system bus that couples various system components including the system memory to the processing unit. The database or system memory may include read only memory (ROM) and random access memory (RAM). The database may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. User interfaces, as described herein may include a computer with monitor, keyboard, a keypad, a mouse, or other input devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangement of the embodiments without departing from the scope of the present invention.

Throughout the specification, numerous advantages of the exemplary embodiments have been identified. It will be understood of course that it is possible to employ the teachings herein without necessarily achieving the same advantages. Additionally, although many features have been described in the context of a particular data processing unit, it will be appreciated that such features could also be implemented in the context of other hardware configurations.

While the exemplary embodiments illustrated in the figures and described above are presently preferred, it should be understood that these embodiments are offered by way of example only. Other embodiments may include, for example, structures with different data mapping or different data. The invention is not limited to a particular embodiment, but extends to various modifications, combinations, and permutations that nevertheless fall within the scope and spirit of the appended claims.

1. A method comprising:
receiving, by an envelope-free deposit slot mechanism of an automated teller machine (ATM) from a user, an authentication printout comprising an ATM access code for an ATM, the ATM access code configured to verify the identity of the user to access the ATM without an ATM card, wherein the authentication printout is remotely printed relative to the ATM and the ATM access code is encoded with information providing access to a database entry of a financial institution computing system that includes parameters specifying permissible features of transactions and information to authenticate the user at the ATM without use of an ATM card, and wherein the authentication printout is a paper printout that is not a check, is not a receipt, and is not an ATM card;
optically scanning, by the envelope-free deposit slot mechanism, the ATM access code;
transmitting, by an authentication circuit of the ATM, an authentication request including the ATM access code to the financial institution computing system;
receiving, by the authentication circuit of the ATM, an authentication for the user to perform transactions at the ATM based on the parameters included in the database entry that specify the permissible features of transactions and the information to authenticate the user at the ATM, without using an ATM card to authenticate the user;
responsive to receiving the authentication for the user, granting the user access to a functionality of an ATM; and
effecting, by a transaction processing circuit of the ATM, a transaction for the user.

2. (canceled)

3. A method according to claim 1, wherein the transaction is a cash withdrawal.

4. (canceled)

5. A method according to claim 1,
wherein the parameters included in the database entry specify a monetary value, and
wherein the method further comprises dispensing cash to the user in the amount of the monetary value.

6. A method according to claim 1, wherein the transaction includes changing one of the parameters included in the database.

7. A method according to claim 1, wherein the transaction is specified by the user at the ATM.

8. A method according to claim 1, wherein the transaction is specified in advance, and wherein stored information included in the database entry regarding the transaction is accessed when the authentication printout is received by the envelope-free deposit slot mechanism from the user.

9. A method according to claim 1, wherein the authenticating is further performed based on a personal identification number (PIN) received from the user at the ATM.

10. (canceled)

11. An automated teller machine (ATM) comprising:
a card reader device configured to read transaction cards;
an envelope-free deposit slot mechanism configured to receive a funds deposit from a user;
control logic configured to cause the deposit slot device to receive an authentication printout from the user and to optically scan information printed on the authentication printout, wherein the authentication printout comprises an ATM access code for an ATM, the ATM access code configured to verify the identity of the user to access the ATM without an ATM card, the authentication printout is remotely printed relative to the ATM and the ATM access code is encoded with information providing access to a database entry of a financial institution computing system that includes parameters including a user specification of a number of uses of the printout and information to authenticate the user at the ATM without use of an ATM card, and wherein the authentication printout is a paper printout that is not a check, is not a receipt, and is not an ATM card;
an authentication circuit configured to authenticate the user to perform transactions at the ATM, without using the ATM card, by transmitting an authentication request including the ATM access code to the financial institution computing system, and receiving an authentication for the user to perform transactions at the ATM based on the parameters included in the database entry including the user specification of the number of uses of the printout and the information to authenticate the user at the ATM, and to grant the user access to a functionality of the ATM; and
a cash dispenser device configured to dispense cash to the user, wherein cash is dispensed to the user responsive to authentication of the user based on the authentication printout.

12. The ATM according to claim 11, wherein the authentication for the user to perform transactions includes authorization to perform a cash withdrawal.

13. (canceled)

14. The ATM according to claim 12,
wherein the parameters included in the database entry specify a monetary value, and
wherein the cash withdrawal is a withdrawal of the amount of the monetary value.

15. A method comprising:
authenticating, by an authentication device, a user during an online banking session, the online banking session being provided to the user via a communication network;
receiving, during the online banking session, user inputs requesting an automated teller machine (ATM) access code for an ATM, the ATM access code providing access to a database entry of the authentication device that includes parameters specifying permissible features of transactions and information to verify the identity of the user to access the ATM without an ATM card;
generating the ATM access code and the database entry including the parameters, the ATM access code providing access to the database entry of the authentication device;
transmitting the ATM access code to the user;
receiving, from the ATM, a request for authentication of a transaction, the request for authentication including the ATM access code and transaction information;
using the ATM access code to access the database entry and to thereby reference the information to verify the identity of the user and reference the parameters of the database entry;
determine, based on transaction information, the information to verify the identity of the user, and the parameters of the database entry, that the transaction is approved; and
providing, responsive to determining that the transaction is approved,
authentication for the transaction to the ATM.

16. A method according to claim 15, wherein the transaction is a cash withdrawal.

17. (canceled)

18. A method according to claim 16,
wherein the parameters of the database entry specify a monetary value, and
wherein the approval comprises approval to dispense cash to the user in the amount of the monetary value.

19. A method according to claim 15, further comprising receiving, along with the request for permission for a transaction, user content from the user.

20. A method according to claim 19, wherein the user content is a photograph.

21. A computer-implemented method comprising:
authenticating, by a financial institution computing system, a user during an online banking session, the online banking session being provided to the user via a communication network;
receiving, during the online banking session, user inputs requesting an authentication printout comprising an ATM access code for an ATM, the ATM access code providing access to a database entry of the authentication device that includes parameters specifying permissible features of transactions and information to verify the identity of the user to access the ATM without an ATM card;
generating, by the financial institution computing system, the database entry including the parameters specifying permissible features of transactions and the information to verify the identity of the user to access the ATM without an ATM card;
generating, by the financial institution computing system, the authentication printout;
transmitting, by the financial institution computing system, the authentication printout;
receiving, by the financial institution computing system from the ATM, a request for authentication for a transaction, the request for authentication including the ATM access code and transaction information;
using, by the financial institution computing system, the ATM access code to access the database entry and to thereby reference the information to verify the identity of the user and reference the parameters of the database entry;
determine, based on the transaction information, the information to verify the identity of the user, and the parameters of the database entry, that the transaction is approved; and
transmitting an approval signal to the ATM responsive to determining that the transaction is approved, the approval signal causing the ATM to dispense the amount of cash.

22. A method according to claim 21,
wherein the transaction is a cash withdrawal;
wherein the parameters specifying permissible features of transactions specify a monetary value; and
wherein the method further comprises dispensing cash to the user in the amount of the monetary value.

23. (canceled)

24. (canceled)

25. The method of claim 1, wherein the authentication printout is used as a temporary ATM card upon the user indicating that the user has lost control of a bank issued ATM card.

26. The method of claim 1, wherein transaction card information that includes information located on a magnetic strip of a transaction card;
further comprising invalidating the transaction card information on the authentication printout after a plurality of PIN attempts by the user.

27. The method of claim 1, wherein the authentication printout is printed by a user using a device owned by the user;
wherein the authentication printout comprises an image of a transaction card of the user.

28. The method of claim 15, wherein:
receiving, during the online banking session, user inputs requesting the ATM access code comprises receiving a user specification of a number of uses of the ATM access code; and
the parameters specifying permissible features of transactions comprise the user specification of the number of uses of the ATM access code.

29. (canceled)

30. The method of claim 15, wherein the ATM access code is transmitted to the user as part of a printable document, and the user transmits the printable document to a third party.

31. The method of claim 21, wherein the information to verify the identity of the user of the database entry includes a user-specified password, and wherein the request for authentication for the transaction includes the user-specified password, the method further comprising matching the user-specified password included in the information to verify the identity of the user of the database entry to the user-specified password included in the request for authentication for the transaction.

32. The method of claim 31, wherein the user-specified password comprises contact information, and the authentication printout is transmitted using the contact information.

33. The method of claim 32, wherein the contact information is for a third-party other than the user, and the authentication printout is transmitted to the third party.
